(19) United States
(12) Patent Application Publication
(10) Pub. No.: US 2025/0011042 A1
(43) Pub. Date: Jan. 9, 2025

(54) PLASTIC CARRIER BAG

(71) Applicant: Mettler Packaging LLC, Raynham, MA (US)

(72) Inventors: Georg Donner, Morbach (DE); Marcel Hornberg, Morbach (DE)

(21) Appl. No.: 18/763,356

(22) Filed: Jul. 3, 2024

(30) Foreign Application Priority Data
Jul. 5, 2023 (EP) 23183739.4

(51) Int. Cl. B65D 33/10; B32B 5/18; B32B 27/06; B32B 27/08; B32B 27/32; B65D 33/02

(52) U.S. Cl. CPC B65D 33/105; B32B 5/18; B32B 27/065; B32B 27/08; B32B 27/32; B65D 33/02; B32B 2439/06

(57) ABSTRACT

A plastic carrier bag includes inner layers and outer layers of the front and rear wall that are each formed in one piece and merge into one another by way of folding over, in some cases with the formation of a bottom fold, wherein an extension of the front and rear wall tapers between the respective first and second side edges in the region of the lower third in the direction of and in particular up to the transition forming a taper/bottom surface region, wherein the lateral extension of the first and the second side wall in the taper/bottom surface region respectively decreases in a corresponding manner in relation to a region in which the extension of the front and rear wall tapers, wherein the first and the second side wall are welded to the front wall in the taper/bottom surface region in a region of their first side edges and are welded to the rear wall in a region of the second side edges.

### BACKGROUND

### Technical Field

The present disclosure relates to a plastic carrier bag, in some cases a plastic carrier bag which can be reused and recycled many times.

### Description of the Related Art

Compared to carrier bags made of paper material, plastic carrier bags are normally advantageous from an ecological and economic point of view if they can frequently be reused and recycled without difficulty. Reusable plastic carrier bags have to meet a certain stability criteria, especially since they are frequently of larger dimensions and are provided with carrier loops on the front and rear walls. Conventional loop bags are described, for example, in DE 101 16 920 A1, WO 01/51372 A1 and DE 40 12 897 A1. These loop bags of the prior art regularly lack sufficient mechanical stability for the repeated carrier of heavy loads.

In some cases, it has proven difficult to satisfy, in some cases the increasing demand for larger-dimensioned reusable plastic carrier bags by way of substantially automated mass production processes and, in addition, to meet the very high requirements of commercial customers of loop carrier bags, such as department stores and wholesale market chains, for the quality of such bags.

Thus, there is accordingly a need of providing carrier bags made of plastic, in some cases large-dimensioned reusable plastic carrier bags, which do not have the disadvantages of the carrier bags of the prior art and which are suitable, in some cases for the repeated reliable transport even of heavy loads and which, in addition, can be produced in a simple and cost-effective manner in mechanical series production.

### BRIEF SUMMARY

Accordingly, a plastic carrier bag has been found with a bottom end and an opposite opening end, comprising a front wall and a rear wall, in each case with a first side edge and an opposite second side edge and also an opening edge, and also a first and an opposite second side wall, in each case with a first and an opposite second side edge, and also at least one holding loop connected to the front wall and/or, in some cases and, at least one holding loop connected to the rear wall, in each case with a first and a second connecting region, wherein the front and rear wall are configured single-layered or multi-layered, in some cases double-layered, comprising at least one inner layer, in some cases one inner layer, and an outer layer, wherein the front and rear wall in the region of the opening end have a reinforcing region, in some cases extending up to or comprising the opening end, containing at least one single-layered or multi-layered, in some cases double-layered, plastic film strip fastened to the front wall on the inside or on the outside, in some cases on the inside, and at least one single-layered or multi-layered, in some cases double-layered, plastic film strip fastened to the rear wall on the inside or on the outside, in some cases on the inside, and extending in each case from or at a distance from the first side edge in the direction of or up to the second side edge.

The plastic carrier bag according to the present disclosure described above is characterized in that the at least one inner layer, in some cases the inner layer, of the front wall and the at least one inner layer, in some cases the inner layer, of the rear wall are formed in one piece, in that the outer layers of the front and the rear wall are formed in one piece, and in that the front wall and the rear wall merge into one another at the bottom end by way of folding over, in some cases form a bottom fold in this transition, wherein the transition, in some cases the bottom fold, extends laterally from a first to an opposite second end, wherein, in the case of the front and the rear wall (also called “stackable storage state”) abutting one another up to the transition, in some cases the bottom fold, the lateral extension of the transition, in some cases of the bottom fold, between the first and second end is smaller than the lateral extension of the front and rear wall between the respective first and second side edge at the opening end, wherein the extension of the front and rear wall between the respective first and second side edge tapers in the region of the lower third, in some cases the lower quarter, with respect to the extension between opening end and bottom end, in the direction of and in some cases up to the transition, in some cases the bottom fold (also referred to as a “tapering/bottom surface region”), wherein the lateral/lateral extension of the first and second side wall in the tapering/bottom surface region in each case decreases, in some cases in a corresponding manner, corresponding to the region in which the extension of front and rear wall tapers between the respective first and second side edge, wherein the first side wall is welded in the tapering/bottom surface region in the region of its first side edge to the front wall, in some cases along the first side edge thereof, and in the region of the second side edge to the rear wall, in some cases along the first side edge thereof, and wherein the second side wall is welded in the tapering/bottom surface region in the region of its first side edge to the front wall, in some cases along the second side edge thereof, and in the region of the second side edge to the rear wall, in some cases along the second side edge thereof.

### BRIEF DESCRIPTION OF THE SEVERAL VIEWS OF THE DRAWINGS

Further features and advantages of the present disclosure result from the following description, in which expedient embodiments of the present disclosure are explained by way of example with reference to schematic drawings. In the figures:

FIG. 1 shows a schematic front side view of a expedient embodiment of a plastic carrier bag according to the present disclosure;

FIG. 2 shows a schematic side view of the blank of a side wall of the plastic carrier bag according to the present disclosure according to FIG. 1;

FIG. 3 shows a schematic perspective view of the plastic carrier bag according to the present disclosure according to FIG. 1;

FIG. 4 shows a schematic plan view of the base surface of the plastic carrier bag according to the present disclosure according to FIG. 1;

FIG. 5 shows a schematic plan view of a blank for a bag body from a front and rear wall of the plastic carrier bag according to the present disclosure according to FIG. 1;

FIG. 6 shows a schematic cross-sectional view of a section of the upper region of the plastic carrier bag according to the present disclosure according to FIG. 1;

FIG. 7 shows a schematic front side view of a further embodiment of a plastic carrier bag according to the present disclosure;

FIG. 8 shows a schematic front side view of a further embodiment of a plastic carrier bag according to the present disclosure;

FIG. 9 shows a schematic front side view of a further embodiment of a plastic carrier bag according to the present disclosure;

FIG. 10 shows a schematic plan view of a blank for a bag body from a front and rear wall of the plastic carrier bag according to the present disclosure according to FIG. 7;

FIG. 11 shows a schematic plan view of a blank for a bag body from a front and rear wall of the plastic carrier bag according to the present disclosure according to FIG. 8;

FIG. 12 shows a schematic plan view of a blank for a bag body from a front and rear wall of the plastic carrier bag according to the present disclosure according to FIG. 9; and

FIG. 13 shows a schematic perspective view of the plastic carrier bag according to the present disclosure according to FIG. 7.

### DETAILED DESCRIPTION

The term lateral extension in the sense of the present disclosure is basically intended to mean the width of the side walls and also the width of the front and rear wall, in other words the distance between the opposite side edges side, front and rear wall. The longitudinal extension of the plastic carrier bag according to the present disclosure accordingly extends perpendicularly thereto between the opening end and the folding over or the bottom fold, respectively.

The present disclosures relating to the plastic carrier bag according to the present disclosure, unless expressly stated otherwise, relate to a state in which the front and rear wall abut flat against one another on a flat base. In this state, the plastic carrier bags according to the present disclosure can be stacked on top of one another in a flat state. This state can also be referred to as a “stackable storage state.” The bottom fold in the plastic carrier bags according to the present disclosure in the stackable storage state in some cases constitutes an outwardly directed bottom fold. By moving the front and rear wall apart, the tapering/bottom surface regions of the front and rear wall become part of the bottom surface, as a result of which the plastic carrier bag according to the present disclosure transitions into an erected filling state. Due to the fact that these tapering/bottom surface regions of the front and rear wall in the stackable storage state lie in the plane of the front or rear wall, respectively and are part of the latter and that these tapering/bottom surface regions in the erected filling state become part of the bottom surface, they are intended to be referred to as tapering/bottom surface regions in the sense of the present disclosure.

With the above-described plastic carrier bag according to the present disclosure, plastic carrier bags with a large capacity volume are accessible by way of large-scale industrial production technology. This is achieved in that side walls are provided, the sections of which tapering towards the bottom end become part of a, in some cases substantially rectangular or square, bottom surface during the filling process. Surprisingly, this, in some cases substantially rectangular or squared, bottom surface can also already be obtained in the unfilled state by simply reaching into the bag interior and pulling apart the front and rear wall. In this filling state, the plastic carrier bag according to the present disclosure is advantageously self-standing with an open opening cross section, so that it can be filled with both hands. These advantageous properties are also established in an expedient embodiment in some cases in that the first and the second side wall each have a, in some cases inwardly pointing, side fold. These side folds in some cases extend as far as the transition, in some other cases as far as the bottom fold, and in some even other cases begin at the opening end of the plastic carrier bag.

Such an embodiment has proven to be expedient in which the first and the second side edge of the first side wall approach, in some cases continuously, in the tapering/bottom surface region and converge in some cases in the region of the transition, in some cases the bottom fold, and in which the first and the second side edge of the second side wall approach, in some cases continuously, in the tapering/bottom surface region and converge in some cases in the region of the transition, in some cases the bottom fold. The first and the second side wall here in some cases have a triangular basic shape in the tapering/bottom surface region. In other words, the opposite side edges of the first and second side wall converge in the tapering/bottom surface region and meet at the bottom end or at the transition from the front to the rear wall, respectively, in some cases they merge into the bottom fold. In the region of the opposite side edges of the first and second side wall, they are welded in the tapering/bottom surface region to the front or the rear wall, respectively, in some cases in each case to the inner side of the front or rear wall, in some cases in the region of the respective side edges of the front and rear wall. In addition to the triangular configuration of the first and second side wall in the tapering/bottom surface region, this surface region can, for example, also be of semicircular, rectangular or squared configuration, the triangular configuration being expedient.

Here, provision can be made, in some cases, for the front wall to taper rectilinearly from the beginning, facing the opening end, of the tapering/bottom surface region at the first side edge up to the first end of the transition, in some cases the bottom fold. Alternatively and, in some cases, in addition, provision can be made for the front wall to taper rectilinearly from the beginning, facing the opening end, of the tapering/bottom surface region at the second side edge as far as the second end of the transition, in some cases the bottom fold. In a corresponding manner, the rear wall can taper rectilinearly from the beginning, facing the opening end, of the tapering/bottom surface region at the first side edge as far as the first end of the transition, in some cases the bottom fold, it being possible, alternatively and, in some cases, in addition, to provide for the rear wall to taper rectilinearly from the beginning, facing the opening end, of the tapering/bottom surface region at the second side edge as far as the second end of the transition, in some cases the bottom fold.

The first and the second side wall are expediently each based on separate material blanks. These material blanks can be individually adapted to the size and shape of the front and rear wall or to the design of the bag main body formed from the front and rear wall, respectively.

Very practicable configurations of the plastic carrier bags according to the present disclosure also provide, in some cases, for the extension from the first to the second side edge of the first side wall to substantially correspond, in some cases correspond, to the sum of the extension of the tapering/bottom surface region of the front wall, calculated from the transition, in some cases the bottom fold, and the extension of the tapering/bottom surface region of the rear wall, calculated from the transition, in some cases the bottom fold. Alternatively and, in some cases, in addition, provision can be made here for the extension from the first to the second side edge of the second side wall to substantially correspond, in some cases correspond, to the sum of the extension of the tapering/bottom surface region of the front wall, calculated from the transition, in some cases the bottom fold, and the extension of the tapering/bottom surface region of the rear wall, calculated from the transition, in some cases the bottom fold.

In the case of a triangular configuration of the first and the second side wall in the tapering/bottom surface region, and in some cases in the case of a rectangular or square configuration of the remaining section of the first or second side wall, provision can be made in one of a plurality of expedient configurations of the plastic carrier bag according to the present disclosure for the width B of the first and/or the second side wall to be determined according to the following formula:

$$B = 2 \times sin ( α - 90 ) \times R ,$$

where
α: angle which the limbs of the first side edge of the front and rear wall form at the transition into the tapering/bottom surface region, and/or, in some cases and, angle which the limbs of the second side edge of the front and rear wall form at the transition into the tapering/bottom surface region,
R: length of the limb of the first side edge of the front and rear wall from the beginning of the tapering/bottom surface region up to the first end of the transition and/or, in some cases and, length of the limb of the second side edge of the front and rear wall from the beginning of the tapering/bottom surface region up to the second end of the transition and
B: width B of the first and/or, in some cases and, of the second side wall in the section which does not correspond to the tapering/bottom surface region.

In a very expedient embodiment of the plastic carrier bag according to the present disclosure, provision can be made here for the front wall to taper rectilinearly from the beginning, facing the opening end, of the tapering/bottom surface region at the first side edge as far as the first end of the transition, in some cases the bottom fold, and/or, in some cases and, for the front wall to taper rectilinearly from the beginning, facing the opening end, of the tapering/bottom surface region at the second side edge as far as the second end of the transition, in some cases the bottom fold, and for the rear wall to taper rectilinearly from the beginning, facing the opening end, of the tapering/bottom surface region at the first side edge as far as the first end of the transition, in some cases the bottom fold, and/or, in some cases and, for the rear wall to taper rectilinearly from the beginning, facing the opening end, of the tapering/bottom surface region at the second side edge as far as the second end of the transition, in some cases the bottom fold.

In yet another, likewise very expedient embodiment of the plastic carrier bag according to the present disclosure, provision can be made for the front wall to taper in a concave shape from the beginning, facing the opening end, of the tapering/bottom surface region at the first side edge as far as the first end of the transition, in some cases the bottom fold, and/or, in some cases and, for the front wall to taper in a concave shape from the beginning, facing the opening end, of the tapering/bottom surface region at the second side edge as far as the second end of the transition, in some cases the bottom fold, and for the rear wall to taper in a concave shape from the beginning, facing the opening end, of the tapering/bottom surface region at the first side edge as far as the first end of the transition, in some cases the bottom fold, and/or, in some cases and, for the rear wall to taper in a concave shape from the beginning, facing the opening end, of the tapering/bottom surface region at the second side edge as far as the second end of the transition, in some cases the bottom fold. As an alternative to the above-described concave tapering, a convex tapering can also be provided. Accordingly, provision can be made in such an embodiment for the front wall to taper in a convex shape from the beginning, facing the opening end, of the tapering/bottom surface region at the first side edge as far as the first end of the transition, in some cases the bottom fold, and/or, in some cases and, for the front wall to taper in a convex shape from the beginning, facing the opening end, of the tapering/bottom surface region at the second side edge as far as the second end of the transition, in some cases the bottom fold, and for the rear wall to taper in a convex shape from the beginning, facing the opening end, of the tapering/bottom surface region at the first side edge as far as the first end of the transition, in some cases the bottom fold, and/or, in some cases and, for the rear wall to taper in a convex shape from the beginning, facing the opening end, of the tapering/bottom surface region at the second side edge as far as the second end of the transition, in some cases the bottom fold.

In a further alternative embodiment, provision can be made for the front wall to taper at the beginning, facing the opening end, of the tapering/bottom surface region at the first side edge in the direction of the opposite second side edge in a first section and to taper less strongly or no longer in the portion adjoining as far as the first end of the transition, in some cases the bottom fold, and/or, in some cases and, for the front wall to taper at the beginning, facing the opening end, of the tapering/bottom surface region at the second side edge in the direction of the opposite first side edge in a first section and to taper less strongly or no longer in the section adjoining as far as the second end of the transition, in some cases the bottom fold, and for the rear wall in a first portion to taper at the beginning, facing the opening end, of the tapering/bottom surface region at the first side edge in the direction of the opposite second side edge and to taper less strongly or no longer in the section adjoining as far as the first end of the transition, in some cases the bottom fold, and/or, in some cases and, for the rear wall to taper in a first portion at the beginning, facing the opening end, of the tapering/bottom surface region at the second side edge in the direction of the opposite first side and to taper less strongly or no longer in the section adjoining as far as the second end of the transition, in some cases the bottom fold. In the last-mentioned embodiment, in one variant, the tapering/bottom surface region can be introduced by a change in the profile of the first and second side edge of the front and rear wall by 90° in each case in relation to the profile of these side edges beyond the tapering/bottom surface region, wherein this profile subsequently changes once again by 90° in each case in the direction of the transition from the front to the rear wall. In this section, the width of the tapering/bottom surface region remains constant.

A high degree of mechanical stability also arises in that, adjacent to or in the region of the first end of the transition, in some cases of the bottom fold, the first side wall, the multi-layered front wall and the multi-layered rear wall are welded to one another and/or, in some cases and in that, adjacent to or in the region of the second end of the transition, in some cases of the bottom fold, the second side wall, the multi-layered front wall and the multi-layered rear wall are welded to one another. In this case, in one embodiment, it is provided that, adjacent to or in the region of the first end of the transition, in some cases of the bottom fold, the first side wall, the front wall and the rear wall are welded to one another in a first area. Alternatively and, in some cases, in addition, provision can be made in this case for, adjacent to or in the region of the second end of the transition, in some cases of the bottom fold, the second side wall, the front wall and the rear wall to be welded to one another in a second area. In some cases, a five-, six-, seven- or eight-layered weld, in some other cases a six- or eight-layered weld, is present in each case in the first area and/or, in some cases and, in the second area. The six-layer-welded first or second area comes about in that the double-layered front wall, the double-layered rear wall and the regions of the first or second side wall which abut against one another, in some cases already welded to the double-layered front wall or the double-layered rear wall, respectively, abut against one another during the welding operation. If a double-layered side wall is used in this procedure, the eight-layer-welded areas are obtained. The embodiments specified above regularly lead to a highly stable bottom surface in the erected filling state and, in some cases, to a plastic carrier bag which can be subjected to a high mechanical load and can frequently be reused.

Surprisingly, it has been found that the plastic carrier bags according to the present disclosure have a pronounced mechanical stability and stability even if the first and the second side wall, unlike the front and rear wall, are of single-layered configuration. Of course, it is likewise possible for the first and the second side wall to be of multi-layer, in some cases double-layer, configuration. As a result, the stability can be increased once again. In many cases, however, even single-layered first and second side walls are already associated with a further increased stability and, in some cases increased stability by virtue of the fact that they have a seam at the opening end. This seam can be configured and obtained, for example, in the same way as the reinforcing regions of the front and rear wall, i.e., with the aid of a continuing section which adjoins the side wall and which is folded over. Here, it has proven to be sufficient for many applications for this continuing section to be folded over onto the inner side or outer side, in some cases the inner side, in a simple manner, i.e., with the formation of only one layer. The seam can also be formed by a separate plastic material strip. The continuing section and also plastic material strips are in some cases connected to the inner side or outer side of the first and second side walls by way of welding.

Such plastic carrier bags according to the present disclosure achieve advantages in a particularly reliable manner, in which the holding loop connected to the front wall and the holding loop connected to the rear wall is welded in each case in their first and second connecting regions to the single-layered or multi-layered, in some cases multi-layered, plastic film strip of the reinforcing region and also to the at least one inner layer, in some cases the inner layer, and the outer layer, and wherein the single-layered or multi-layered, in some cases multi-layered, plastic film strip of the reinforcing region of the front wall is fastened by way of welding to the inner or outer layer from or at a distance from the first side edge in the direction of or as far as the second side edge, and wherein the single-layered or multi-layered, in some cases multi-layered, plastic film strip of the reinforcing region of the rear wall is fastened by way of welding to the inner or outer layer from or at a distance from the first side edge in the direction of or as far as the second side edge, wherein the first and second connecting regions of the holding loop connected to the front wall and the first and second connecting regions of the holding loop connected to the rear wall are present on the inner side of the front or rear wall in the region of the single-layered or multi-layered, in some cases multi-layered, plastic film strip of the reinforcing region, wherein in each case a continuing section adjoins the outer layer, wherein the continuing section forms the plastic film strip of the reinforcing region, wherein the continuing section extends at least in sections along the inner side of the at least one inner layer, in some cases the inner layer, and abuts thereon, wherein this continuing section present on the inner side of the at least one inner layer, in some cases the inner layer, is at least double-layered at least in regions by way of folding over, wherein this continuing section is welded to the inner side of the at least one inner layer, in some cases the inner layer, along an extension from or at a distance from the first side edge in the direction of or up to the second side edge, in some cases by way of a continuous longitudinal weld, and wherein the outer layer of the front and rear wall, in some cases in the transition to the continuing section, comprises or forms the opening edge, and wherein the at least one inner layer, in some cases the inner layer, extends with its upper edge up to the opening edge or at a distance therefrom, wherein the outer layer and the continuing section of the front wall and the outer layer and the continuing section of the rear wall are each formed in one piece, and wherein the single-layered or multi-layered, in some cases double-layered, plastic film strip of the reinforcing region of the front and rear wall is welded in each case via all its layers to the inner side of the at least one inner layer, in some cases the inner layer, along the extension from or at a distance from the first side edge in the direction of or up to the second side edge, in some cases by way of a continuous longitudinal weld, forming a first connecting region, in some cases connecting strip, wherein this first connecting region, in some cases first connecting strip, is present in each case closer to the lower edge of the reinforcing region than to the upper edge thereof, in some cases at or adjacent to the lower edge of the reinforcing region, wherein the outer layer of front and rear wall is welded in each case to the outer side of the at least one inner layer, in some cases the inner layer, along the extension from or at a distance from the first side edge in the direction of or up to the second side edge, in some cases by way of a continuous longitudinal weld, forming a second connecting region, in some cases second connecting strip, wherein this second connecting region, in some cases second connecting strip, is present in each case closer to the lower edge of the reinforcing region than to the upper edge thereof, in some cases at or adjacent to the lower edge of the reinforcing region, wherein the first and second connecting regions, obtained by way of welding, of the holding loops connected to the front wall and/or to the rear wall are present at a distance from the first and second connecting regions, in some cases the first and second connecting strips, in some cases have no overlap with the first and second connecting regions, wherein the holding loop connected inside to the front wall and/or inside to the rear wall on is welded in each case in its first and second connecting regions, directly or indirectly, to the single-layered or multi-layered, in some cases multi-layered, plastic film strip of the reinforcing region and to the at least one inner layer, in some cases the inner layer, and the outer layer.

With the above-described embodiment according to the present disclosure of a plastic carrier bag, a pronounced reinforcement is made available, in some cases, also in the upper edge region, which reinforcement withstands high mechanical loads and provides a very effective basis for the connection of holding loops. The plastic carrier bag provided with such a reinforcing region can also be opened comfortably and without problems.

Highly suitable plastic carrier bags according to the present disclosure are also distinguished in that, in the portion which is not the tapering/bottom surface region, the first side wall is welded in the region of its first side edge to the front wall, in some cases along the first side edge thereof, and in the region of the second side edge to the rear wall, in some cases along the first side edge thereof, wherein, in the portion which is not the tapering/bottom surface region, the second side wall is welded in the region of its first side edge to the front wall, in some cases along the second side edge thereof, and in the region of the second side edge to the rear wall, in some cases along the second side edge thereof.

The plastic carrier bags according to the present disclosure are in some cases produced from thermoplastics, wherein polyolefinic thermoplastics, in some cases polyethylene, are expedient. The connection by way of welding in these cases regularly constitutes a thermoplastic welding. Accordingly, the plastic carrier bags according to the present disclosure are in some cases produced completely from thermoplastics, in some other cases polyolefinic thermoplastics such as polyethylene. In this way, pure-grade plastic bags which are highly durable to recycling are obtained.

The outer layer of the front and rear wall of the plastic carrier bag according to the present disclosure regularly constitutes an individual layer. If a further layer is present on the inside and adjacent to the outer layer, this is to be counted among the inner layers or constitutes the inner layer. If the continuing section is present in one piece with the outer layer, this continuing section also necessarily has to be single-layer. The one layered configuration of the outer layer of front and rear wall does not rule out the possibility that the outer layer can be multi-layered and can be present, for example, as a coextrusion film. A single-layered outer layer can also have a laminated layer on the inside and/or on the outside without losing the character of being one layered. In the case of multi-layered systems, the layers are accordingly present in a close bond. The outer layer and the inner layer or the plurality of the inner layers, respectively, are accordingly connected to one another in a expedient embodiment only via the weld along their side edges. Alternatively, provision can also be made for the outer layer and the inner layer or the plurality of the inner layers, respectively, to be partially connected to one another, for example via individual weld or adhesive points, in some cases weld points.

In an expedient embodiment of the above-specified plastic carrier bag, provision can be made here for the holding loop connected to the front wall via its first and second connecting regions and the holding loop connected to the rear wall via its first and second connecting regions to have, in the region from the respective first to the second connecting region, at least in sections, a first flexible, in some cases tubular, hollow body and/or a single-layered or multi-layered material strip, in some cases plastic material strip, which does not form a hollow body, and which is encased at least in sections, in some cases substantially completely, by a second flexible, in some cases tubular, hollow body.

With regard to the holding loops of the plastic carrier bags according to the present disclosure, preference is given to those in which the first flexible, in some cases tubular, hollow body is formed from a first flexible plastic material strip with opposite first and second longitudinal side edges, the opposite first and second longitudinal side edges of which are welded and/or adhesively bonded to one another in an overlapping region, and/or, in some cases and, in which the second flexible, in some cases tubular, hollow body is formed from a second flexible plastic material strip with opposite first and second longitudinal side edges, the opposite first and second longitudinal side edges of which are welded and/or adhesively bonded to one another in a second overlapping region.

The first and second flexible plastic material strips, for example in the form of polyolefin film strips, in some cases polyethylene film strips, can have a rectangular shape in an expedient configuration, if spread out over a large area. The longitudinal edges of these material strips can then be moved towards one another and connected to one another in the overlapping region, forming the first or second, in some cases tubular, hollow body, respectively. Here, the first longitudinal side edge can come to bear against the second longitudinal side edge both above and below the latter in an overlapping region.

A high degree of strength also arises here, in some cases, in that the first plastic material strip of the first flexible, in some cases tubular, hollow body and the second plastic material strip of the second flexible, in some cases tubular, hollow body are welded and/or adhesively bonded to one another at least in sections, in some cases along the first and second overlapping regions.

In many cases, it has proven expedient to carry out the welding of first and second plastic material strips in the first and respectively second overlapping region in a single method step, i.e., substantially simultaneously. This gives rise to a uniform weld seam extending along the, in some cases tubular, holding loop. This embodiment has the further advantage that the first and the second flexible hollow body are connected to one another in the region of this uniform weld seam, as a result of which a further increase in mechanical strength results. Alternatively, the first and the second, in some cases tubular, hollow body can also be connected to one another in regions or continuously along their entire length, in some cases along a connecting strip, without the first and second overlapping regions themselves overlapping in this connecting region.

In an alternative embodiment, with regard to the connection of the first and second flexible hollow body it can be provided that the first flexible, in some cases tubular, hollow body is formed from a first flexible plastic material strip with opposite first and second longitudinal side edges, and that the second flexible, in some cases tubular, hollow body is formed from a second flexible plastic material strip with opposite first and second longitudinal side edges, wherein, in the overlapping region of first and second longitudinal side edge of the first flexible plastic material strip, the first longitudinal side edge of the first plastic material strip is welded and/or adhesively bonded to the first longitudinal side edge of the second material strip, and this first longitudinal side edge of the second plastic material strip is welded and/or adhesively bonded to the second longitudinal side edge of the first plastic material strip, and wherein in the overlapping region of first and second longitudinal side edge of the second flexible plastic material strip, the second longitudinal side edge of the first plastic material strip is welded and/or adhesively bonded to the second longitudinal side edge of the second material strip, and this second longitudinal side edge of the first plastic material strip is welded and/or adhesively bonded to the first longitudinal side edge of the second plastic material strip.

For many applications, it has proven expedient to resort to such plastic carrier bags in which the first holding loop containing the first and second flexible, in some cases tubular, hollow body and/or the second holding loop containing the first and second flexible, in some cases tubular, hollow body are pressed flat to form two opposite longitudinal fold edges, wherein the overlapping regions of the opposite first and second longitudinal side edges of first and second flexible plastic material strips of the first and second flexible hollow body of first and/or second holding loop are in some cases present between the opposite longitudinal fold edges and in some cases on the same side. As an alternative, provision can also be made for the first holding loop containing the single-layered or multi-layered material strip which does not form a hollow body and the second flexible, in some cases tubular, hollow body and/or the second holding loop containing the single-layered or multi-layered material strip which does not form a hollow body and the second flexible, in some cases tubular, hollow body to be pressed flat to form two opposite longitudinal fold edges, wherein the overlapping region of the opposite first and second longitudinal side edges of second flexible plastic material strips of the second flexible hollow body of first and/or second holding loop are in some cases present between the opposite longitudinal fold edges. With the aid of the preceding configurations, the pre stage for the holding loop can be stored temporarily wound on a roll in a flat-pressed state and can be separated therefrom if required. The flat-pressed holding loop also imparts a pleasant wearing feel and permits a uniform distribution of the carrier forces.

A further advantageous configuration in some cases also of the preceding embodiment, provides that, in the first and/or second connecting region of, in some cases flat-pressed, first and/or second holding loop, that side of the, in some cases flat-pressed, holding loop is the connecting side which does not have the overlapping regions of the opposite first and second longitudinal side edges of first and second flexible plastic material strip of the first and second flexible hollow body. Surprisingly, it has been found that good mechanical stability and tensile strength are achieved in this way.

With the holding loops for the plastic carrier bags according to the present disclosure, it is also possible to realize such embodiments in which the second flexible, in some cases tubular, hollow body of the holding loop of front and/or rear wall, in some cases the second flexible plastic material strip which forms or contains the second flexible, in some cases tubular, hollow body of the holding loop of front and/or rear wall, is based on a plastic material, in some cases polyethylene, which is transparent at least in sections and which can be printed or is printed at least in sections on the inside, in some cases by way of reverse printing methods. Since, in the described configuration, the pressure is present on the inside of the second hollow body of the holding loop, this is not impaired during wearing, for example by abrasion. This is also achieved with an embodiment in which the first flexible, in some cases tubular, hollow body or the single-layered or multi-layered material strip, in some cases plastic material strip, of the holding loop of front and/or rear wall, which does not form a hollow body, can be printed or is printed on the outside at least in sections, and in that the second flexible, in some cases tubular, hollow body of the holding loop is based on or consists of a plastic material, in some cases polyethylene, which is transparent at least in sections. The preceding configurations of the plastic carrier bag according to the present disclosure also permit the holding loop or the holding loops to be used as an information or advertising medium carrier or for the attachment of design elements.

Furthermore, it can be provided in the sense of the present disclosure that the outer layer of front and/or rear wall is based on or consists of a plastic material, in some cases polyethylene, which is transparent at least in sections and which can be printed or is printed at least in sections on the inside, in some cases by way of reverse printing methods. Furthermore, the plastic carrier bag according to the present disclosure alternatively or additionally comprises at least one inner layer, in some cases the inner layer, of front and/or rear wall, which can be printed or is printed at least in sections on the outside, and wherein the outer layer is based on or consists of a plastic material, in some cases polyethylene, which is transparent at least in sections.

A high degree of stability and tensile strength is also achieved in that, in the abovementioned embodiments, a non-foamed plastic film, in some cases a non-foamed polyolefin film, particularly in some cases a non-foamed polyethylene film and in some cases a non-foamed LD polyethylene film, is used for an outer layer of a plastic carrier bag according to the present disclosure. The combination of a foamed plastic inner layer and a non-foamed plastic outer layer surprisingly leads here to plastic carrier bags which can be subjected to a high mechanical load and are permanently stable. The same applies to expedient configurations of the holding loop in which the second flexible, in some cases tubular, hollow body, in some cases the second flexible plastic material strip, is based on or formed from a non-foamed plastic film, in some cases a non-foamed polyolefin film, in some other cases a non-foamed polyethylene film and in some even other cases a non-foamed LD polyethylene film.

Accordingly, in a very expedient configuration, it can be provided that the outer layer, the single-layered or multi-layered, in some cases double-layered, plastic film strip of the reinforcing region, in some cases the continuing section of the inner layer or outer layer, and the at least one inner layer, in some cases the inner layer, of front and rear wall, the first and the second side wall as well as optionally the holding loops connected to the front wall and to the rear wall, in some cases the first and/or second flexible plastic material strips thereof or the single-layered or multi-layered material strips thereof which do not form a hollow body, are formed or consist of polyethylene, in some cases LD polyethylene, wherein the at least one inner layer, in some cases the inner layer, of front and rear wall is a foamed polyethylene film, in some cases a foamed LD polyethylene film, and wherein the outer layer of front and/or rear wall, and if appropriate the single-layered or multi-layered, in some cases multi-layered, plastic film strip of the reinforcing region, is a non-foamed polyethylene film, in some cases a non-foamed LD polyethylene film. In this context, plastic carrier bags are highly expedient in which the first flexible, in some cases tubular, hollow body or the single-layered or multi-layered material strip of the holding loop of front and/or rear wall, which does not form a hollow body, in some cases the first flexible plastic material strip, is formed or consists of foamed polymer material, in some cases foamed polyethylene, and in some other cases foamed LD polyethylene, and wherein in some cases the second flexible, in some other cases tubular, hollow body of the holding loop of front and/or rear wall, in some cases the second flexible plastic material strip, is formed or consists of non-foamed polymer material, in some cases non-foamed polyethylene, and in some other cases non-foamed LD polyethylene.

In the sense of the present disclosure, the outer layer, the single-layered or multi-layered, in some cases double-layered, plastic film strip of the reinforcing region, in some cases the continuing section of the inner or outer layer, and/or the at least one inner layer, in some cases the inner layer, of front and/or rear wall are expediently present in film form.

A high degree of stability and tensile strength is also achieved in the abovementioned embodiments of a plastic carrier bag according to the present disclosure in that the first and second connecting regions, obtained in some cases by way of welding, of the holding loops connected to the front wall and/or to the rear wall are present at a distance from the first and/or second connecting strip, in some cases do not overlap with the first and/or second connecting strip.

In the plastic carrier bag according to the present disclosure, it is in some cases provided that the outer layer, the single-layered or multi-layered, in some cases double-layered, plastic film strip of the reinforcing region, in some cases the continuing section of the inner and/or outer layer, and the at least one inner layer, in some cases the inner layer, of front and/or rear wall and optionally the holding loops connected to the front wall and/or to the rear wall, in some cases the first and/or second flexible plastic material strips thereof and/or the single-layered or multi-layered material strip which does not form a hollow body, are formed or consist of polyolefins, in some cases polyethylene. As an alternative to polyethylene, use can also be made of polypropylene. Copolymers with ethylene or propylene are likewise suitable as the main component, wherein, for the further comonomers, use can be made, for example, of propylene or ethylene and/or butene, for example 1-butene, or butadiene.

It is in some expedient cases provided that the outer layer, the single-layered or multi-layered, in some cases double-layered, plastic film strip of the reinforcing region, in some cases the continuing section of the outer layer, and the at least one inner layer, in some cases the inner layer, of front and rear wall and the holding loops connected to the front wall and to the rear wall, in some cases the first and/or second flexible plastic material strips thereof and/or the single-layered or multi-layered material strip which does not form a hollow body, and the first and the second side wall are formed or consist of polyolefins, in some cases polyethylene, particularly in some other cases HD or LD polyethylene, in some even other cases LD polyethylene.

In some cases, a uniform plastic material, for example polypropylene or polyethylene, in some other cases polyethylene and in some even other cases LD polyethylene, is used throughout for all the components of the plastic carrier bag according to the present disclosure, for example for the inner and outer layer of front and rear wall and for the holding loops of front and rear wall and for the first and second side wall. This gives a pure-grade plastic carrier bag which can be recycled as such without problems.

Furthermore, among the plastic carrier bags according to the present disclosure, those are highly suitable in which the at least one inner layer, in some cases the inner layer, of the front and/or, in some cases and, rear wall comprises or constitutes a foamed plastic film, in some cases a foamed polyolefin film, in some other cases a foamed polyethylene film and in some cases a foamed LD polyethylene film. As a result, a textile-like appearance in the handling, for example during folding, of the plastic carrier bag according to the present disclosure can be reinforced. In a corresponding manner, the first flexible, in some cases tubular, hollow body or the single-layered or multi-layered material strip which does not form a hollow body can also comprise or consist of a foamed plastic film, in some cases a foamed polyolefin film, in some other cases a foamed polyethylene film and in some even cases a foamed LD polyethylene film.

In some cases, among the polyethylenes, use is made of LD polyethylene.

In an expedient configuration of the plastic carrier bag according to the present disclosure, it can be provided that the holding loop connected to the front wall and/or to the rear wall, in some cases on the inside, is welded and/or adhesively bonded in each case in its first and second connecting regions, directly or indirectly, to the single-layered or multi-layered, in some cases multi-layered, plastic film strip of the reinforcing region, and to the at least one inner layer, in some cases the inner layer, and the outer layer, wherein, in these first and second connecting regions, at least the inner side of the second hollow body of the holding loop, in some cases the inwardly facing side of the second flexible plastic material strip, is welded and/or adhesively bonded to the outer side of the first hollow body or the facing side of the single-layered or multi-layered material strip which does not form a hollow body, in some cases the outwardly facing side of the first flexible plastic material strip.

If the first and second connecting regions of the holding loop abut directly against the plastic film strip of the reinforcing region, the connection to the at least one inner layer, in some cases the inner layer, and the outer layer takes place regularly indirectly, i.e., via the respectively abutting adjacent layer. In a corresponding manner, if the first and second connecting regions of the holding loop abut directly against the outer layer or the inner layer, the connection to the at least one inner layer, in some cases the inner layer, or the outer layer, respectively, and the layer(s) of the plastic film strip of the reinforcing region can take place in each case regularly indirectly, i.e., via the respectively abutting adjacent layer. In some configurations, a mixing of the melted material of the layers involved can occur, for example, during the welding, so that a clear assignment of the material to the layers is no longer possible.

In some cases for producing a pleasant feel which comes close to that of textile holding loops, it has proven to be advantageous for the first flexible, in some cases tubular, hollow body, in some cases the first flexible plastic material strip, or the single-layered or multi-layered material strip which does not form a hollow body and/or the second flexible, in some cases tubular, hollow body, in some cases the second flexible plastic material strip, of the holding loop of the front and/or rear wall to have an embossing pattern at least in sections, in some cases over the entire surface. Such embossing patterns can be produced reliably and permanently, for example when using thermoplastics, for example polyolefins, by the action of heat and pressure.

For many embodiments of the plastic carrier bags according to the present disclosure, it has proven to be pragmatic to form the opening edge by a fold at the upper end of the outer layer or in the transition region from the outer layer to the continuing section.

A connection or welding, respectively, of the plastic film strip or of the continuing section of the front and/or rear wall to the at least one inner layer, in some cases the inner layer, for example the inner side of the inner layer, in some cases includes the connection of all layers which abut against one another here. The same generally applies to the connection of the plastic film strip or of the continuing section of the front and/or rear wall to the outer layer.

In a highly expedient embodiment, provision is made for, in addition, the outer layer of the front and/or rear wall to be welded and/or adhesively bonded to the outer side of the at least one inner layer, in some cases the inner layer, along the extension of or at a distance from the first side edge in the direction of or up to the second side edge, in some cases with a continuous longitudinal weld, under the formation of a second connecting strip, wherein this second connecting strip is in some cases present at a closer distance from the lower edge of the reinforcing region than from the upper edge thereof, in some cases at or adjacent to the lower edge of the reinforcing region. As a result, a further reinforced opening edge is obtained. It is very expedient here if the first and the second connecting strip are present at least in sections, in some cases completely, substantially overlapping.

The plastic carrier bag according to the present disclosure, in some cases the pure-grade plastic carrier bag according to the present disclosure, can be configured here in such a way that the outer layer, the single-layered or multi-layered, in some cases double-layered, plastic film strip of the reinforcing region, in some cases the continuing section of inner or outer layer, and/or the at least one inner layer, in some cases the inner layer, of the front and/or rear wall, the first and the second side wall and the holding loops connected to the front wall and/or to the rear wall, in some cases the first and/or second flexible plastic material strips thereof or the multi-layered material strip which does not form a hollow body, contain or consist of recycled plastic material, in some cases recycled polyolefins, for example polyethylene.

Furthermore, the present disclosure also comprises such plastic carrier bags with a bottom end and an opposite opening end, comprising a front wall and a rear wall, in each case with a first side edge and an opposite second side edge and an opening edge, and a first and an opposite second side wall with in each case a first and an opposite second side edge and at least one holding loop connected to the front wall and/or, in some cases and, at least one holding loop connected to the rear wall with in each case a first and a second connecting region, in which the front and the rear wall are configured in a single-layered or multi-layered, in some cases double-layered, comprising at least one inner layer, in some cases one inner layer, and an outer layer, wherein the front and the rear wall have, in the region of the opening end, a reinforcing region, in some cases extending up to or comprising the opening end, containing at least one single-layered or multi-layered, in some cases double-layered, plastic film strip fastened to the front wall on the inside or on the outside, in some cases on the inside, and at least one single-layered or multi-layered, in some cases double-layered, plastic film strip fastened to the rear wall on the inside or on the outside, in some cases on the inside, and extending in each case from or at a distance from the first side edge in the direction of or up to the second side edge. This embodiment is characterized in that the at least one inner layer, in some cases the inner layer, of the front wall and the at least one inner layer, in some cases the inner layer, of the rear wall are configured in one piece, in that the outer layers of the front and rear wall are configured in one piece, and in that the front wall and the rear wall transition into one another at the bottom end by way of folding over, in some cases form a bottom fold in this transition, wherein the transition, in some cases the bottom fold, extends laterally from a first to an opposite second end, wherein the first and the second side wall have a squared, rectangular or trapezoidal blank, wherein the front wall and the rear wall are welded to the first side wall in the region of their first side edges, and wherein the front wall and the rear wall are welded to the second side wall in the region of their second side edges, in some cases forming a squared or rectangular bottom surface in the erected filling state. Here, in this embodiment, the lateral extension of the transition, in some cases of the bottom fold, between the first and second end is substantially identical, in some cases identical, to the extension of the front and the rear wall between the respective first and the second side edge at the opening end.

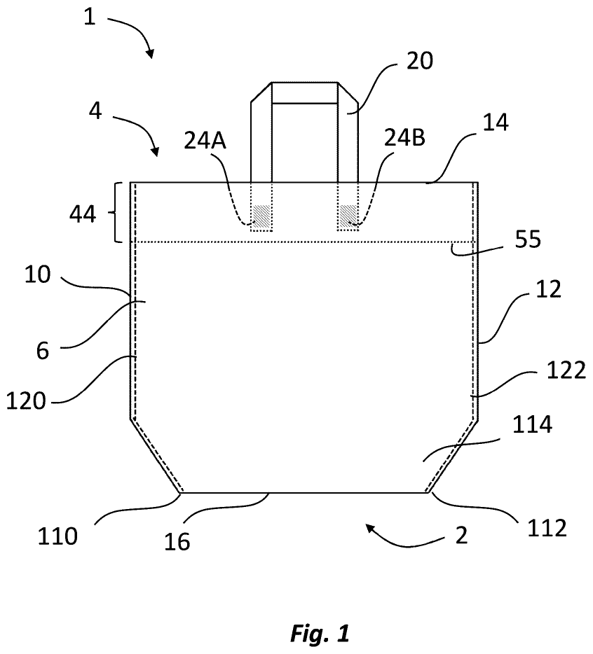

FIG. 1 shows a schematic front side view of a plastic carrier bag 1 according to the present disclosure. In the embodiment shown, the double-layered front wall 6 merges at the bottom end 2 by way of folding over in one piece into the double-layered rear wall 8, under forming a bottom fold 16 in the transition. That is to say, the inner layers 28, 3) of front and rear wall 6, 8 are formed in one piece, and the outer layers 30, 34 of the front and rear wall 6, 8 are likewise formed in one piece. The bottom fold 16 has a lateral extension from the first 110 to the opposite second end(112 which is smaller than the lateral extension of the front and rear wall in the region of the opening end 4. In the tapering/bottom surface region 114, 114′ which lies in the lower third of the plastic carrier bag according to the present disclosure, the first and second side edges 10, 12 of the front and rear wall 6, 8 converge rectilinearly at an obtuse angle onto the first or second end 110, 112 of the bottom fold 16. The front and the rear wall 6, 8 are connected to one another (not shown) by way of weld seams 120, 122 running in the region of the first and second side edges 10, 12 to the first and the second side wall 102, 104. The front and the rear wall 6, 8 have, in the region of the opening end 4, a reinforcing region 44, 46 extending up to the opening end, containing in each case a double-layered plastic film strip 106, 108 fastened on the inside to the front wall 6 or on the inside to the rear wall 8, respectively, and extending in each case from the first side edge 10 to the second side edge 12. This double-layered plastic film strip 106, 108 can be a separate component, but in some cases constitutes an integral, that is to say a one-piece part of the outer layer and is accordingly formed from a continuing section of the outer layer of front or rear wall. This continuing section initially forms the opening edge 14 by folding over. By folding over again, in some cases facing the inner side of the inner wall, an expedient reinforcement is achieved in the upper region of the carrier bag by the doubled layer associated therewith. In the embodiment shown, this continuing section is welded along a connecting strip 55 to the inner layer 28 and, via the latter, also to the outer layer 30. The same applies to the rear wall 8 (not shown). The front wall 6 and the rear wall 8 are each connected to the bag body by a holding loop 20, 22 via their first and second connecting regions 24A, 24B; 26A, 26B. The first and second connecting regions 24A, 24B; 26A, 26B of the holding loops 20, 22 for front and rear wall are present here completely in the respective reinforcing regions 44, 46 and have no overlap with the connecting strip 55.

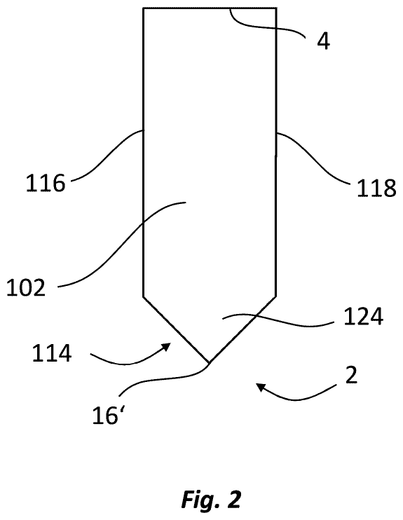

FIG. 2 shows a schematic side view of the blank of a first side wall 102 of the plastic carrier bag 1 according to the present disclosure according to FIG. 1. The first and second side edges 116, 118 run parallel to one another in the region beginning with the upper end 4 of the plastic carrier bag 1 according to the present disclosure. Where the plastic carrier bag 1 according to the present disclosure transitions into the tapering/bottom surface region 114, 114′ (see FIG. 1), the parallel profile of these side edges ends and they converge symmetrically toward one another in order to meet at a point 16′ which lies on the longitudinal central axis of the side wall. These tapering sections 124, 126 of the first and second side wall 102, 104 have a triangular shape in expedient configurations. If this side wall is a side fold wall, the side fold runs regularly along the longitudinal central axis.

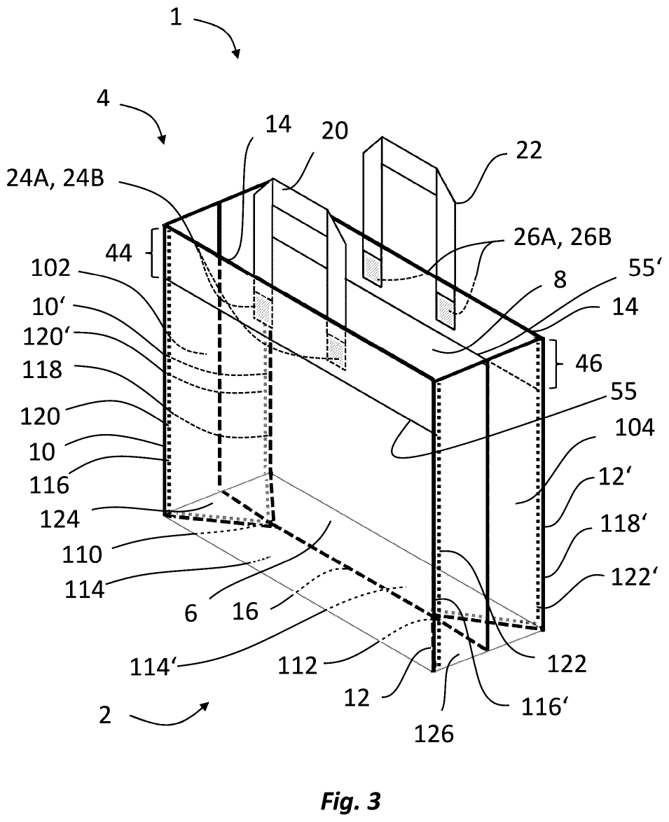

FIG. 3 shows a schematic perspective view of the plastic carrier bag 1 according to the present disclosure according to FIG. 1 in the erected filling state. The bottom surface is formed in this erected state by parts of the front and rear wall 6, 8 in the tapering/bottom surface region 114, 114′ and by the triangular tapering/bottom surface regions 124, 126 of the first and second side wall 102, 104. In the embodiment shown, the side walls 102, 104 are welded along their side edges 116, 118; 116′, 118′ to the inner sides of the front and rear wall 6, 8, likewise along their side edges 10, 12; 10′, 12′, under the formation of weld seams 120, 122; 120′, 122′.

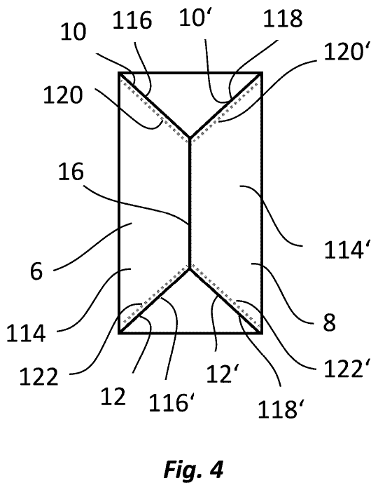

FIG. 4 shows a schematic plan view of the bottom surface of the plastic carrier bag (1) according to the present disclosure in the filling state.

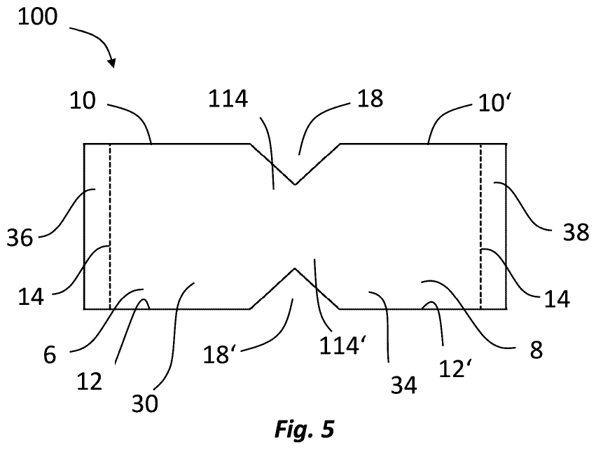

FIG. 5 shows a schematic plan view of a blank 100 for the outer layer 30, 34 of the front and rear wall 6, 8 of the plastic carrier bag 1 according to the present disclosure. The outer layer of front and rear wall 6, 8 are formed in one piece. They likewise contain in each case the respective continuing sections 36, 38 which form the opening edge 14 and the double-layered plastic material strip of the reinforcing region 44, 46 by way of folding over. In the region of the transition from the front to the rear wall, there are triangular material omissions 18, 18′ which form the tapering/bottom surface region 114, 114′ after the front and rear wall section have been folded over on one another, including the single-piece inner layers of the front and rear wall (not shown), and joining these to the correspondingly shaped first or second side wall.

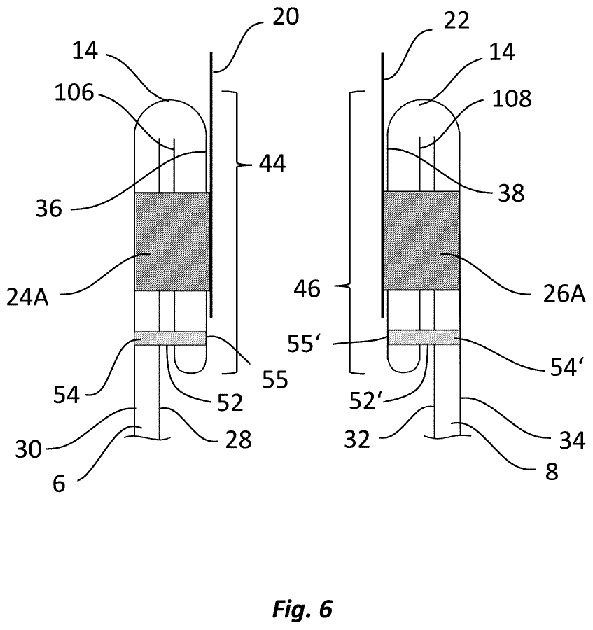

FIG. 6 shows the upper region of the plastic carrier bag 1 according to the present disclosure. The continuing sections 36, 38 are folded over around the inner layers 28, 32 and also folded over inwards once again around themselves and are thus present in double-layered form. These double-layered continuing sections 36, 38 are welded to one another, welded to the inner side of the inner layer 28, 32, forming the connecting regions 52, 52′, furthermore the inner layer 28, 32 is also welded to the respective outer layer 30, 34, forming the connecting regions 54, 54′. The connecting regions 52, 52′ and 54, 54′ are present here in each case overlapping in the embodiment shown and form a uniform welding section 55, 55′ which can also be obtained, in some cases, in a single welding step. The holding loops 20, 22, likewise shown in detail in FIG. 6, are welded on the inside to the folded-over double-layered continuing sections 36, 38 in the first connecting regions 24A, 26A shown. Furthermore, the outer layer 30, 34, the inner layer 28, 30 and the folded-over continuing section 36, 38 are present in each case welded to one another in these connecting regions 24A, 26A. In this way, a very stable plastic carrier bag 1 which can be subjected to a high mechanical load is obtained. In addition, a replication-free filling of the plastic carrier bags according to the present disclosure can be ensured by the shown internal attachment of the holding loops. The upper ends or opening edges, respectively, are prevented with the aid of the carrier loops from serving as abutting edges during filling with piece goods.

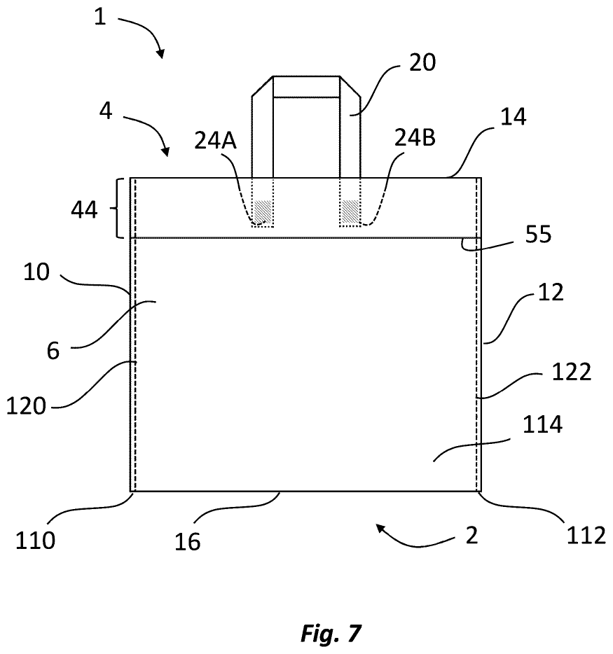

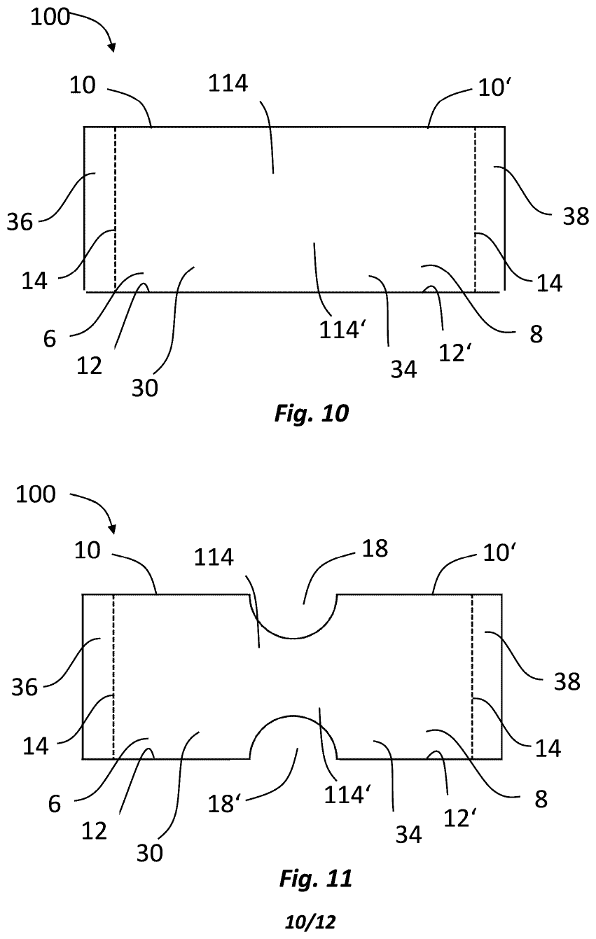

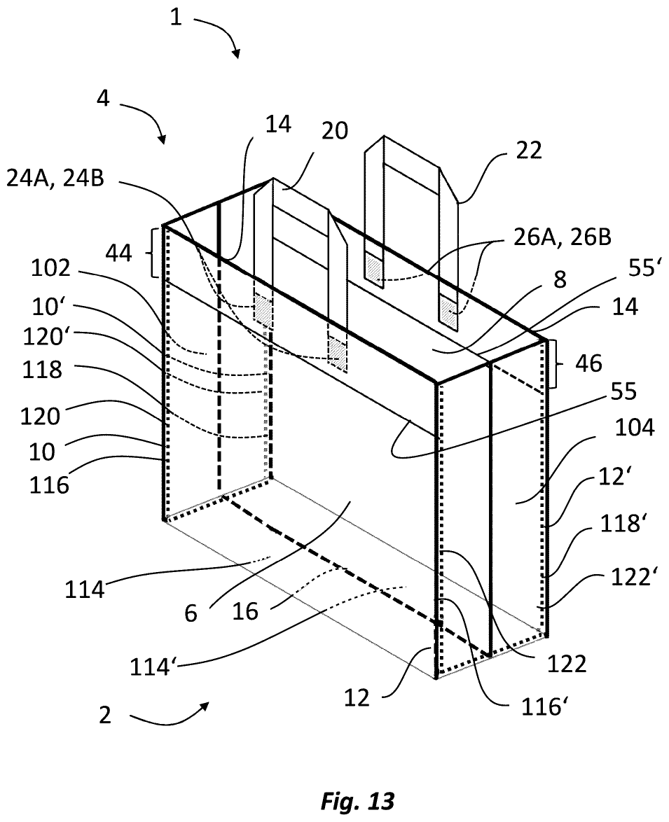

FIG. 7 shows a schematic front side view of a further embodiment of a plastic carrier bag according to the present disclosure. This embodiment of a carrier bag according to the present disclosure differs from the embodiments shown in FIG. 1 in that the first and second side edges of the front and rear wall run rectilinearly from the upper end 4 to the folding over or the bottom fold 16, respectively, and accordingly no tapering section is present in the lower region of the carrier bag. FIG. 10 shows a schematic plan view of a blank 100 for the outer layer 30, 34 of the front and rear wall 6, 8 of the embodiment of a plastic carrier bag 1 according to the present disclosure according to FIG. 7. The outer layer of the front and rear wall 6, 8 are formed in one piece. They likewise contain in each case the respective continuing sections 36, 38 which form the opening edge 14 and the double-layered plastic material strip of the reinforcing region 44, 46 by way of folding over. In the region of the transition from the front to the rear wall, unlike the embodiment according to FIG. 1, there are no material omissions. Accordingly, the first and the second side wall are present as separate rectangular material sections, as can also be seen from the schematic perspective view of the carrier bag of this embodiment according to FIG. 13. The side edges of the first and second side wall are welded to the side edges of the front and rear wall. The width of the first and second side wall also defines here the width of the bottom surface of the carrier bag in the erected filling state. The reference symbols of this embodiment of a carrier bag relate for the most part to features such as have also already been used for the expedient embodiment of a carrier bag according to FIG. 1.

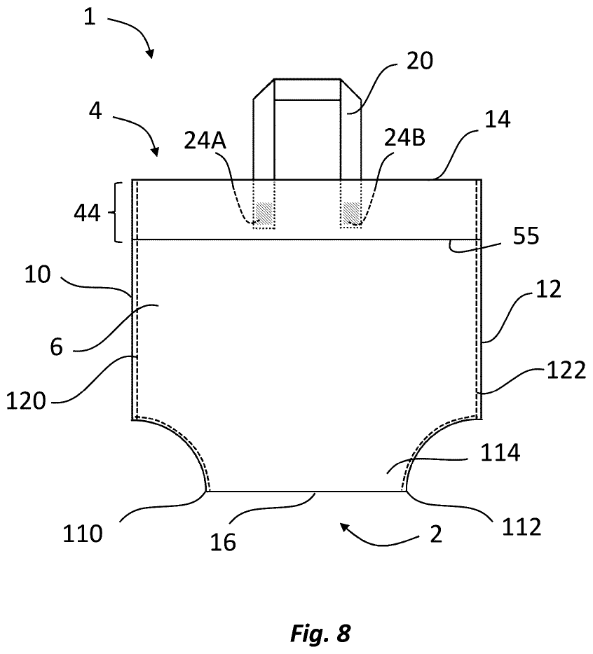

FIG. 8 shows a schematic front side view of a further embodiment of a plastic carrier bag according to the present disclosure. This embodiment differs from the embodiment according to FIG. 1 in that, in the tapering/bottom surface region 114 which lies in the lower third of the plastic carrier bag according to the present disclosure, the first and second side edges 10, 12 of the front and rear wall 6, 8 taper in a in a concave shape curved manner in the direction of the first or second end 110, 112 of the bottom fold 16. FIG. 11 shows a schematic plan view of a blank 100 for the outer layer 30, 34 of the front and rear wall 6, 8 of this embodiment of a plastic carrier bag 1 according to the present disclosure. The outer layer of the front and rear wall 6, 8 are also formed in one piece here. They likewise contain in each case the respective continuing sections 36, 38 which form the opening edge 14 and the double-layered plastic material strip of the reinforcing region 44, 46 by way of folding over. In the region of the transition from the front to the rear wall, there are semicircular material omissions 18, 18′ which form the tapering/bottom surface region 114, 114′ after the front and rear wall section have been folded over on one another, including the single-piece inner layers of the front and rear wall, and joining them to the first and second side wall.

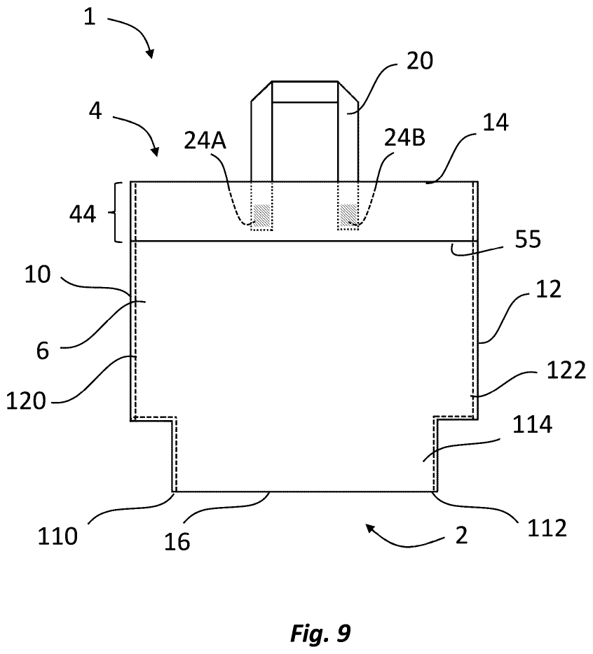

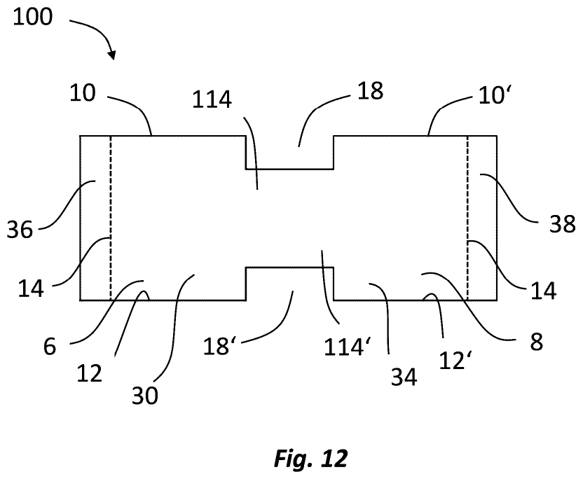

FIG. 9 shows a schematic front side view of a further embodiment of a plastic carrier bag according to the present disclosure. This embodiment differs from the embodiment according to FIG. 1 in that, in the tapering/bottom surface region 114 which lies in the lower third of the plastic carrier bag according to the present disclosure, the first and second side edges 10, 12 of the front and rear wall 6, 8 taper without transition, i.e., in each case forming a right angle. The tapering/bottom surface region 114 thus obtained then has a uniform width or lateral extension, respectively, up to the bottom fold 16. FIG. 12 shows a schematic plan view of a blank 100 for the outer layer 30, 34 of the front and rear wall 6, 8 of this embodiment of a plastic carrier bag 1 according to the present disclosure. The outer layer of the front and rear wall 6, 8 are also formed in one piece here. They likewise contain in each case the respective continuing sections 36, 38 which form the opening edge 14 and the double-layered plastic material strip of the reinforcing region 44, 46 by way of folding over. In the region of the transition from the front to the rear wall, as shown in FIG. 12, there are rectangular material omissions 18, 18′ which form the tapering/bottom surface region 114, 114′ after the front and rear wall section have been folded over on one another, including the single-piece inner layers of the front and rear wall, and joining them to the first and second side wall.

The features of the present disclosure disclosed in the above description, in the claims and in the drawings can be essential both individually and in any desired combination for the realization of the present disclosure in its various embodiments.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A plastic carrier bag, comprising:
a bottom end and an opposite opening end,
a front wall and a rear wall, each with a first side edge and an opposite second side edge as well as an opening edge,
a first side wall and an opposite second side wall, each with a first side edge and an opposite second side edge, and
at least one holding loop connected to the front wall or at least one holding loop connected to the rear wall, each with a first connecting region and a second connecting region,
wherein the front wall and the rear wall are configured multi-layered comprising at least one inner layer and an outer layer,
wherein the front wall and the rear wall in the region of the opening end have a reinforcing region containing at least one multi-layered plastic film strip fastened to the front wall on the inside or on the outside and at least one multi-layer plastic film strip fastened to the rear wall on the inside or on the outside and extending in each case from or at a distance from the first side edge in a direction of or up to the second side edge,
wherein the at least one inner layer of the front wall and the at least one inner layer of the rear wall are configured in one piece, wherein the outer layers of the front wall and the rear wall are configured in one piece, and wherein the front wall and the rear wall merge into one another at the bottom end by way of folding over, wherein the transition extends laterally from a first end to an opposite second end,
wherein, in the case of the front wall and the rear wall abutting one another up to the transition, the lateral extension of the transition between the first end and second end is smaller than the extension of the front wall and rear wall between the respective first side edge and second side edge at the opening end,
wherein the extension of the front wall and rear wall between the respective first side edge and second side edge tapers in a region of the lower third with respect to the extension between opening end and bottom end, in the direction of the transition forming a tapering/bottom surface region,
wherein the lateral extension of the first side wall and second side wall in the tapering/bottom surface region in each case decreases corresponding to a region in which the extension of front wall and rear wall tapers between the respective first side edge and second side edge,
wherein the first side wall is welded in the tapering/bottom surface region in a region of its first side edge to the front wall and in a region of the second side edge to the rear wall, and
wherein the second side wall is welded in the tapering/bottom surface region in a region of its first side edge to the front wall and in a region of the second side edge to the rear wall.

2. The plastic carrier bag according to claim 1, wherein the first side edge and second side edge of the first side wall approach in the tapering/bottom surface region, and wherein
the first side edge and second side edge of the second side wall approach in the tapering/bottom surface region.

3. The plastic carrier bag according to claim 1, wherein in the portion which is not the tapering/bottom surface region, the first side wall is welded in the region of its first side edge to the front wall, and in the region of the second side edge to the rear wall, and
wherein in the portion which is not the tapering/bottom surface region, the second side wall is welded in the region of its first side edge to the front wall, and in the region of the second side edge to the rear wall.

4. The plastic carrier bag according to claim 1, wherein the extension from the first side edge to the second side edge of the first side wall substantially corresponds to a sum of the extension of the tapering/bottom surface region of the front wall, calculated from the transition and the extension of the tapering/bottom surface region of the rear wall, calculated from the transition, or
wherein the extension from the first side edge to the second side edge of the second side wall substantially corresponds to a sum of the extension of the tapering/bottom surface region of the front wall, calculated from the transition and the extension of the tapering/bottom surface region of the rear wall, calculated from the transition.

5. The plastic carrier bag according to claim 1, wherein the first side wall and the second side wall are configured triangular, semicircular, rectangular, or squared in the tapering/bottom surface region.

6. The plastic carrier bag according to claim 1, wherein adjacent to or in the region of the first end of the transition, the first side wall, the front wall, and the rear wall are welded to one another in a first area, or
wherein adjacent to or in the region of the second end of the transition the second side wall, the front wall, and the rear wall are welded to one another in a second area.

7. The plastic carrier bag according to claim 6, wherein a five-, six-, seven- or eight-layered weld is present in each case in the first area and in the second area.

8. The plastic carrier bag according to claim 1, wherein the front wall tapers in a rectilinear line from the beginning, facing the opening end, of the tapering/bottom surface region at the first side edge as far as the first end of the transition, or
wherein the front wall tapers in a rectilinear line from the beginning, facing the opening end, of the tapering/bottom surface region at the second side edge as far as the second end of the transition and wherein the rear wall tapers in a rectilinear line from the beginning, facing the opening end, of the tapering/bottom surface region at the first side edge as far as the first end of the transition, or
wherein the rear wall tapers in a rectilinear line from the beginning, facing the opening end, of the tapering/bottom surface region at the second side edge as far as the second end of the transition, or
wherein the front wall tapers in a concave shape from the beginning, facing the opening end, of the tapering/bottom surface region at the first side edge as far as the first end of the transition, or wherein the front wall tapers in a concave shape from the beginning, facing the opening end, of the tapering/bottom surface region at the second side edge as far as the second end of the transition, and wherein the rear wall tapers in a concave shape from the beginning, facing the opening end, of the tapering/bottom surface region at the first side edge as far as the first end of the transition, or wherein the rear wall tapers in a concave shape from the beginning, facing the opening end, of the tapering/bottom surface region at the second side edge as far as the second end of the transition, or
wherein the front wall tapers in a convex shape from the beginning, facing the opening end, of the tapering/bottom surface region at the first side edge as far as the first end of the transition, or wherein the front wall tapers in a convex shape from the beginning, facing the opening end, of the tapering/bottom surface region at the second side edge as far as the second end of the transition, and wherein the rear wall tapers in a convex shape from the beginning, facing the opening end, of the tapering/bottom surface region at the first side edge as far as the first end of the transition, or wherein the rear wall tapers in a convex shape from the beginning, facing the opening end, of the tapering/bottom surface region at the second side edge as far as the second end of the transition, or
wherein the front wall tapers in a first portion at the beginning, facing the opening end, of the tapering/bottom surface region at the first side edge in the direction of the opposite second side edge and tapers less strongly or no longer in the portion adjoining as far as the first end of the transition, or
wherein the front wall tapers in a first portion at the beginning, facing the opening end, of the tapering/bottom surface region at the second side edge in the direction of the opposite first side edge and tapers less strongly or no longer in the portion adjoining as far as the second end of the transition, and wherein the rear wall tapers in a first portion at the beginning, facing the opening end, of the tapering/bottom surface region at the first side edge in the direction of the opposite second side edge and tapers less strongly or no longer in the portion adjoining as far as the first end of the transition, or
wherein the rear wall tapers in a first portion at the beginning, facing the opening end, of the tapering/bottom surface region at the second side edge in the direction of the opposite first side edge and tapers less strongly or no longer in the portion adjoining as far as the second end of the transition.

9. A plastic carrier bag, comprising:
a bottom end and an opposite opening end,
a front wall and a rear wall, each with a first side edge and an opposite second side edge as well as an opening edge,
a first side wall and an opposite second side wall each with a first side edge and an opposite second side edge,
at least one holding loop connected to the front wall or to the rear wall, each with a first connecting region and a second connecting region,
wherein the front wall and the rear wall are configured multi-layered comprising at least one inner layer and an outer layer, wherein the front wall and the rear wall in the region of the opening end have a reinforcing region containing at least one multi-layered plastic film strip fastened to the front wall on the inside or on the outside and at least one multi-layer plastic film strip fastened to the rear wall on the inside or on the outside and extending in each case from or at a distance from the first side edge in a direction of or up to the second side edge,
wherein the at least one inner layer of the front wall and the at least one inner layer of the rear wall are configured in one piece, wherein the outer layers of front wall and rear wall are configured in one piece, and wherein the front wall and the rear wall merge into one another at the bottom end by way of folding over,
wherein the transition extends laterally from a first end to an opposite second end, wherein the lateral extension of the transition between the first end and second end is substantially identical to the extension of the front wall and rear wall between the respective first side edge and second side edge at the opening end,
wherein the first side wall and the second side wall have a squared, rectangular, or trapezoidal blank,
wherein the front wall and the rear wall are welded in a region of their first side edges to the first side wall, and
wherein the front wall and the rear wall are welded in a region of their second side edges to the second side wall.

10. The plastic carrier bag according to claim 1, wherein the at least one holding loop connected to the front wall and the at least one holding loop connected to the rear wall is welded in each of its first and second connecting regions to the multi-layered plastic film strip of the reinforcing region and also to the at least one inner layer and the outer layer, and
wherein the multi-layered plastic film strip of the reinforcing region of the front wall is fastened by way of welding to the inner or outer layer from or at a distance from the first side edge in the direction of or up to the second side edge, and wherein the multi-layered plastic film strip of the reinforcing region of the rear wall is fastened by means of welding to the inner or outer layer from or at a distance from the first side edge in the direction of or up to the second side edge,
wherein the first and second connecting regions of the at least one holding loop connected to the front wall and the first and second connecting regions of the at least one holding loop connected to the rear wall are present on the inner side of the front or rear wall in the region of the multi-layered plastic film strip of the reinforcing region,
wherein a continuing section adjoins in each case the outer layer, wherein the continuing section forms the plastic film strip of the reinforcing region,
wherein the continuing section extends at least in sections along the inner side of the at least one inner layer, and abuts thereon,
wherein this continuing section present on the inner side of the at least one inner layer is configured at least double-layered at least in regions by means of folding over,
wherein this continuing section is welded to the inner side of the at least one inner layer along an extension from or at a distance from the first side edge in the direction of or up to the second side edge, and
wherein the outer layer of front wall and rear wall comprises or forms the opening edge,
wherein the at least one inner layer extends with its upper edge up to the opening edge or at a distance therefrom,
wherein the outer layer and the continuing section of the front wall and the outer layer and the continuing section of the rear wall are each configured in one piece, and
wherein the multi-layered plastic film strip of the reinforcing region of front wall and rear wall is welded in each case over all its layers to the inner side of the at least one inner layer along the extension from or at a distance from the first side edge in the direction of or up to the second side edge forming a first connecting region, wherein this first connecting region is present in each case closer to the lower edge of the reinforcing region than to the upper edge thereof,
wherein the outer layer of front wall and rear wall is welded in each case to the outer side of the at least one inner layer along the extension from or at a distance from the first side edge in the direction of or up to the second side edge forming a second connecting region,
wherein the second connecting region is present in each case closer to the lower edge of the reinforcing region than to the upper edge thereof,
wherein the first and second connecting regions, obtained by way of welding, of the holding loops connected to the front wall or to the rear wall are present at a distance from the first and second connecting regions, and
wherein the at least one holding loop connected inside to the front wall or the at least one holding loop connected inside to the rear wall is welded in each case in its first and second connecting regions, directly or indirectly, to the multi-layered plastic film strip of the reinforcing region and to the at least one inner layer and the outer layer.

11. The plastic carrier bag according to claim 1, wherein the first side wall and the second side wall are single-layered.

12. The plastic carrier bag according to claim 1, wherein the first side wall and the second side wall have a side fold.

13. The plastic carrier bag according to claim 1, wherein the first side wall and the second side wall have a seam at the opening end.

14. The plastic carrier bag according to claim 1, wherein the first side wall and the second side wall are based on separate material blanks.

15. The plastic carrier bag according to claim 1, wherein a bottom fold in the erected filling state of the plastic carrier bag constitutes an outwardly directed bottom fold.

16. The plastic carrier bag according to claim 1, wherein the outer layer is based on or consists of a plastic material which is transparent at least in sections and which can be printed or is printed at least in sections on the inside, or
wherein the at least one inner layer can be printed or is printed at least in sections on the outside, and wherein the outer layer is based on or consists of a plastic material which is transparent at least in sections.

17. The plastic carrier bag according to claim 1, wherein the outer layer, the multi-layered plastic film strip of the reinforcing region, the at least one inner layer of the front or rear wall, and the holding loops connected to the front wall or to the rear wall, and the first side wall and the second side wall are formed or consist of polyolefins.

18. The plastic carrier bag according to claim 1, wherein the at least one inner layer of the front wall and rear wall comprises or constitutes a foamed plastic film, or
wherein the outer layer of the front wall and rear wall comprises or constitutes a non-foamed plastic film.

19. The plastic carrier bag according to claim 1, wherein the outer layer, the multi-layered plastic film strip of the reinforcing region, the at least one inner layer of front wall and rear wall, and the holding loops connected to the front wall and to the rear wall and the first side wall and the second side wall are formed or consist of polyethylene, wherein the at least one inner layer of front wall and rear wall constitutes a foamed polyethylene film, and wherein the outer layer of front or rear wall constitutes a non-foamed polyethylene film.

20. The plastic carrier bag according to claim 1, wherein the first connecting regions overlap in each case with the second connecting regions.

21. The plastic carrier bag according to claim 1, wherein the front wall and the rear wall or the plastic film strips fastened to the front or rear wall are configured double-layered.

22. The plastic carrier bag according to claim 1, wherein the reinforcing region extends up to or comprises the opening end.

23. The plastic carrier bag according to claim 1, wherein the plastic film strip is fastened to the front wall on the inside.

24. The plastic carrier bag according to claim 1, wherein the extension of the front wall and rear wall tapers up to the transition.

25. The plastic carrier bag according to claim 1, wherein the lateral extension of the first side wall and second side wall in the tapering/bottom surface region in each case decreases in a corresponding manner corresponding to the region in which the extension of front wall and rear wall tapers between the respective first side edge and second side edge.

26. The plastic carrier bag according to claim 1, wherein the first side wall is welded in the tapering/bottom surface region in the region of its first side edge to the front wall along the first side edge thereof, or in the region of the second side edge to the rear wall along the first side edge thereof, or
wherein the second side wall is welded in the tapering/bottom surface region in the region of its first side edge to the front wall along the second side edge thereof, or in the region of the second side edge to the rear wall along the second side edge thereof.

27. The plastic carrier bag according to claim 2, wherein the first side edge and second side edge of the first side wall approach continuously, or wherein the first side edge and second side edge of the second side wall approach continuously, or
wherein the first side edge and second side edge of the first side wall converge in the region of the transition, or wherein the first side edge and second side edge of the second side wall converge in the region of the transition.

28. The plastic carrier bag according to claim 3, wherein in the portion which is not the tapering/bottom surface region, the first side wall is welded in the region of its first side edge to the front wall along the first side edge thereof, or in the region of the second side edge to the rear wall along the first side edge thereof, or
wherein in the portion which is not the tapering/bottom surface region, the second side wall is welded in the region of its first side edge to the front wall along the second side edge thereof, or in the region of the second side edge to the rear wall along the second side edge thereof.

29. The plastic carrier bag according to claim 4, wherein the extension from the first side edge to the second side edge of the first or second side wall substantially corresponds to the sum of the extension of the tapering/bottom surface region of the front wall.

30. The plastic carrier bag according to claim 9, wherein the lateral extension of the transition between the first end and second end is identical to the extension of the front wall and rear wall between the respective first side edge and second side edge at the opening end.

31. The plastic carrier bag according to claim 9, wherein the front wall and the rear wall are welded in the region of their second side edges to the second side wall forming a squared or rectangular bottom surface in the erected filling state.

32. The plastic carrier bag according to claim 10, wherein the first and second connecting regions of the holding loops connected to the front wall or to the rear wall have no overlap with the first and second connecting regions.

33. The plastic carrier bag according to claim 12, wherein the side fold extends as far as the transition.

34. The plastic carrier bag according to claim 19, wherein the multi-layered plastic film strip of the reinforcing region constitutes a non-foamed polyethylene film.
